(19) United States
(12) Patent Application Publication
(10) Pub. No.: US 2011/0161879 A1
(43) Pub. Date: Jun. 30, 2011

(54) ELECTRONIC DEVICE AND METHOD OF BROWSING IMAGES THEREON

(75) Inventor: TENG-YU TSAI, Tu-Cheng (TW)

(73) Assignee: HON HAI PRECISION INDUSTRY CO., LTD., Tu-Cheng (TW)

(21) Appl. No.: 12/702,322

(22) Filed: Feb. 9, 2010

(30) Foreign Application Priority Data
Dec. 31, 2009 (CN) 200910312915.5

(51) Int. Cl. G06F 3/048; G06F 12/08

(52) U.S. Cl. 715/817; 711/118; 711/E12.017

(57) ABSTRACT

A method of browsing images on an electronic device includes displaying an index. The index defines F items. Each item has an item number. A display shows G images with image numbers. All the image numbers are defined from 1 to N. The item number corresponds to the image number. The item with the item number F/2 is located at a center of the display. The item located on the left side of the display is considered as variable f. The index is moved along a first direction. The display shows the items with the item numbers from f to f+G−1. The item with the item number F/2 is moved to the center of the display if the item number f is smaller than a first value adjacent to 1 or bigger than a second value adjacent to F.

### BACKGROUND

1. Technical Field

The present disclosure relates to electronic devices, and particularly to a method of browsing images on an electronic device.

2. Description of Related Art

Electronic devices (such as digital photo frames) typically allow image browsing by touching the display. Images are stored in a flash storage of the electronic device. The electronic device decodes the images and stores the images in a buffer memory for displaying on the display. However, when a large number of images are stored in the flash storage, a large buffer memory is needed to temporarily store the images for displaying. This can increase the cost of the electronic device. Therefore there is room for improvement in the art.

### BRIEF DESCRIPTION OF THE DRAWINGS

FIG. 1 shows a block diagram of an electronic device in accordance with one embodiment.

FIG. 2 is a block diagram of the electronic device in accordance with one embodiment.

FIG. 3 is a schematic view of an index corresponding to images in an initial position.

FIG. 4 is a schematic view of the index corresponding to the images in a middle process.

FIG. 5 is a schematic view of the index corresponding to the images finally.

FIG. 6 is a flowchart of a method of browsing images on electronic devices such as that of FIG. 1.

FIG. 7 is a flowchart of a method of displaying enlarged images on electronic devices such as that of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module,” as used herein, refers to logic embodied in hardware or firmware, or to a collection of software instructions, written in a programming languages such as Java, C, or Assembly. One or more software instructions in the modules may be embedded in firmware, such as an EPROM. It is noteworthy, that modules may comprise connected logic units, such as gates and flip-flops, and programmable units such as programmable gate arrays or processors. The modules described herein may be implemented as software and/or hardware modules and may be stored in any type of computer-readable medium or other computer storage device.

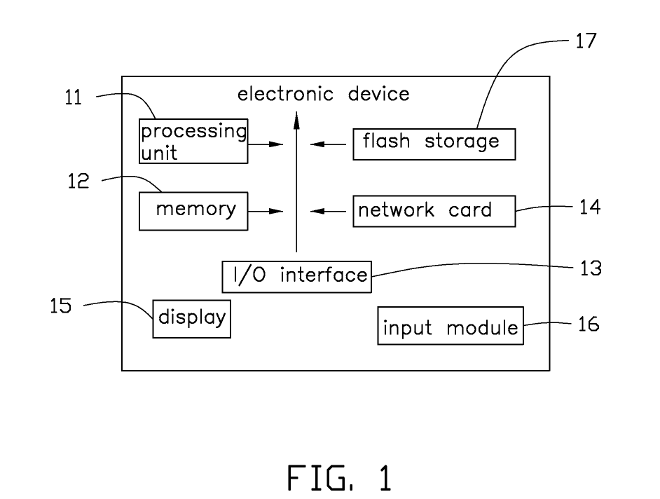

Referring to FIG. 1, an electronic device includes a processing unit 11, a memory 12, an Input/Output (I/O) interface 13, a network card 14, a display 15, an input module 16 and a flash storage 17. The display 15 is touch-sensitive and displays a user interface. The input module 16 may be a remote controller. The electronic device may be a digital photo frame, a media player, or a personal computer.

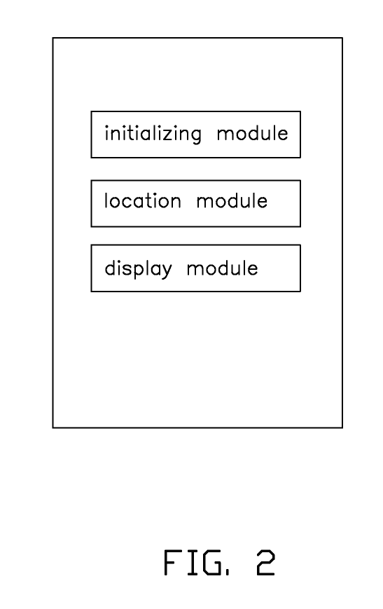

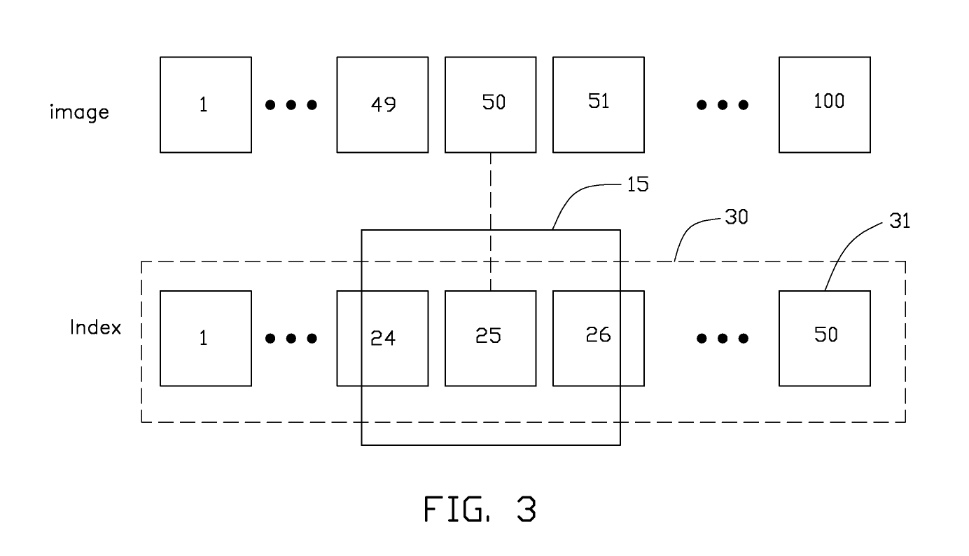

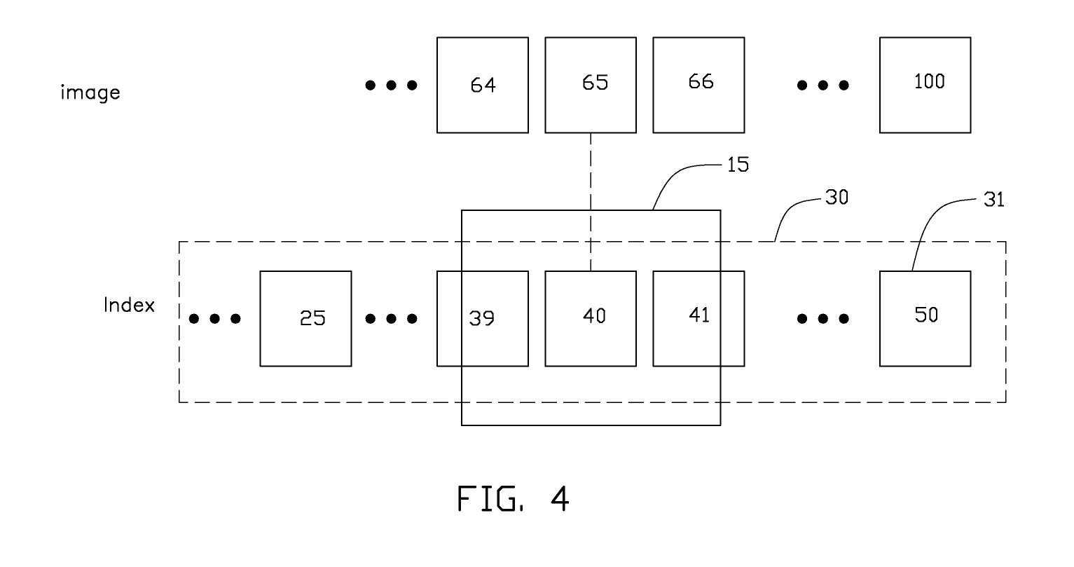

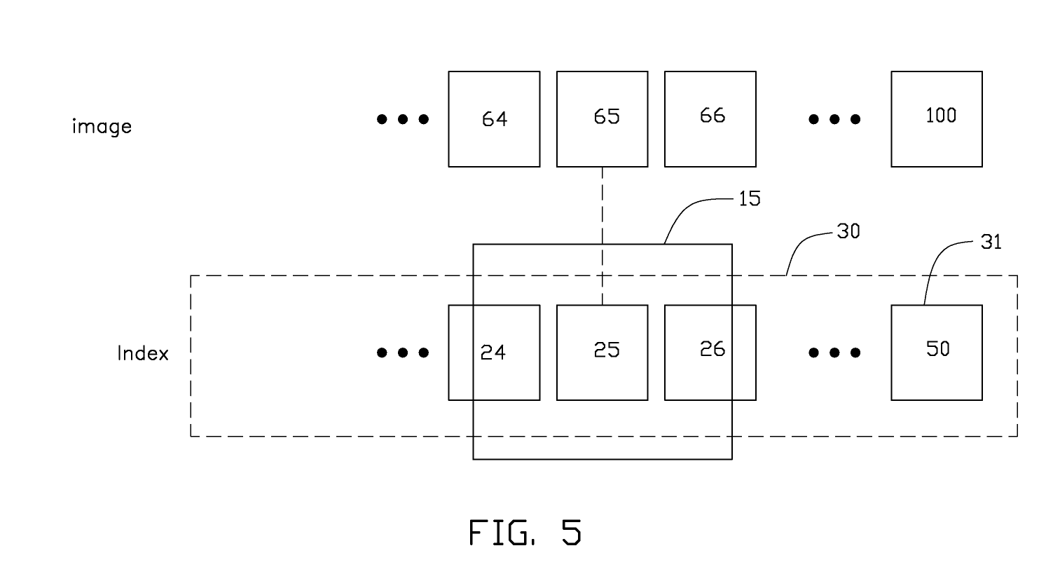

Referring to FIGS. 2-5, the electronic device includes an initializing module, a location module, and a display module. The initializing module establishes an index 30. The index 30 defines F number of items 31 (F being a number greater than zero) and stores them in the flash storage 17. Items 31 are not actually visible images but a tracking system for scrolling through viewable images stored, for example, in the memory 12. In this embodiment, the index 30 has 50 items 31. Each item 31 has an item number. The display 15 displays G number of items 31 (G being a number greater than zero) at one time. In this embodiment, G=3, that is there are three items on the display 15 at the same time; a left, a middle, and right item. The item with the item number F/2, or (F/2)+1/2 if F is an odd number, is the initial item 31 displayed in a center position when the electronic device is turned on.

Each item number can be defined in relation to a variable f. The display 15 shows items 31 with item numbers from f to f+G−1. The item located on the left side of the display 15 is considered as variable f. For example, when F=50 and G=3 then the range of items displayed is from f to f+2. Initially the items on the display 15 would be f=(F/2)−1=24 as the left item 31, f=25 as the middle item 31, and f=26 as the right item 31. The flash storage stores N images. The images are on the top of the items 31. Image numbers may be defined from 1 to N. In one embodiment, N=100. The item with the item number 25 corresponds to the image with the image number 50 upon initialization of the electronic device. The initializing module initializes G groups of memory blocks. Each group includes two memory units. One memory unit stores the item numbers f to f+G−1. Another memory unit stores corresponding images.

Although there may be many more images N stored and labeled in order from 1-N, and much fewer items 31, all images can be viewed by a user using sliding touches on the display. Initially the item F/2 may be associated with a predetermined image according to user changeable factory default setting such as N/2 or N/2+1/2 if N is an odd number and so item 24 is associated with image N/2−1, and item 26 is associated with image number N. Once a user stops scrolling if the current item is near or at the beginning or end of the items, the items are reset so that item F/2 becomes associated with whatever image is currently in the center index position on the display. In this way less memory are used to store items.

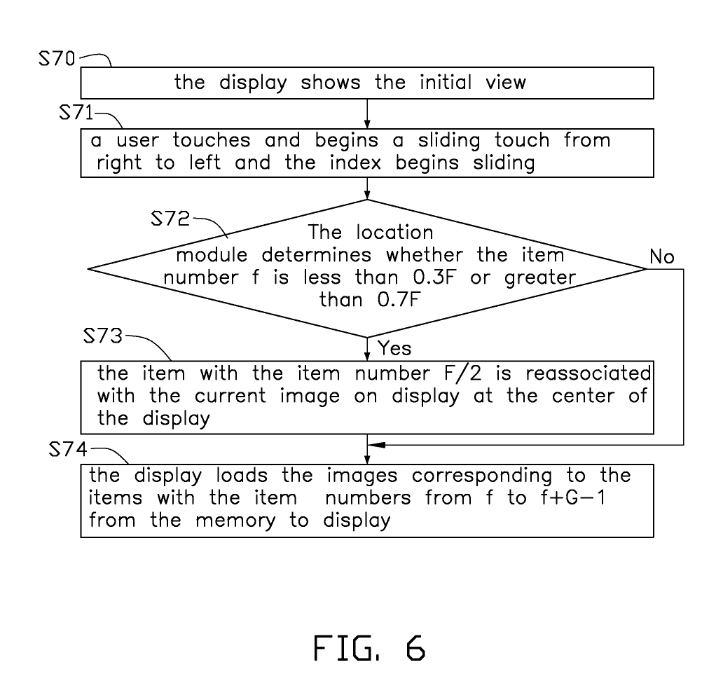

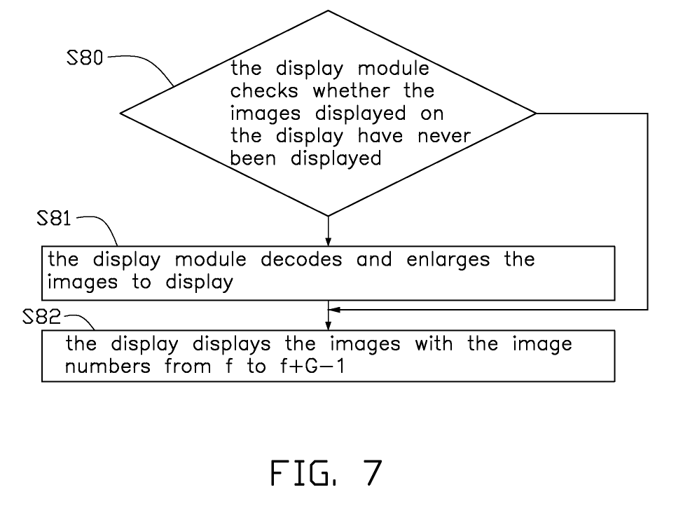

Referring to FIGS. 6-7, one embodiment of a method of browsing images using an electronic device includes the following blocks.

In this example, the index 30 can be scrolled left or right and a user touches the screen and slides right to left causing the index 30 to slide from right to left. In block S70, the display 15 shows the initial view, which includes the items 31 with the item numbers from 24 to 26 in this embodiment.

In block S71, a user touches and begins a sliding touch from right to left and the index 30 begins sliding.

In block S72, the display 15 displays the items 31 with the item numbers from f to f+G−1 when the index 30 stops sliding. The location module determines whether the item number f is less than 0.3 F or greater than 0.7 F. If the item number f is less than 0.3 F or greater than 0.7 F, go on S73; if not, skip to S74.

In block S73, the item 31 with the item number F/2 is reassociated with the current image on display at the center of the display 15. In one embodiment, 0.7 F=35. The item 31 with the item number 25 is moved to the center of the display 15.

In block S74, the display 15 loads the images corresponding to the items 31 with the item numbers from f to f+G−1 from the memory 12 to display.

Referring to FIG. 8, one embodiment of a method of showing images by an electronic device includes the following blocks.

In block S80, the display module checks whether the images displayed on the display 15 have never been displayed. If the images are being displayed for the first time, it proceeds to S81; if not, skip to S82.

In block S81, the display module decodes and enlarges the images to be displayed.

In block S82, the display 15 displays the images with the image numbers from f to f+G−1. In one embodiment, the display 15 shows the images with the image numbers from 64 to 66. The index 30 may be slid up and down.

While the present disclosure has been illustrated by the description of preferred embodiments thereof, and while the preferred embodiments have been described in considerable detail, it is not intended to restrict or in any way limit the scope of the appended claims to such details. Additional advantages and modifications within the spirit and scope of the present disclosure will readily appear to those skilled in the art. Therefore, the present disclosure is not limited to the specific details and illustrative examples shown and described.

Depending on the embodiment, certain of the steps of methods described may be removed, others may be added, and the sequence of steps may be altered. It is also to be understood that the description and the claims drawn to a method may include some indication in reference to certain steps. However, the indication used is only to be viewed for identification purposes and not as a suggestion as to an order for the steps.

What is claimed is:

1. A method of browsing images on an electronic device, the method comprising:
displaying a index, wherein the index defines F items, each item has an item number, a display displays G images with image numbers, all the image numbers are defined from 1 to N, the item with the item number F/2 is located at a center of the display;
moving the index along a first direction, the display displaying the items with the item numbers from f to f+G−1;
moving the item with the item number F/2 to the center of the display if the item number f is smaller than a first value adjacent to 1 or bigger than a second value adjacent to F;
displaying the images with the image numbers corresponding to the item numbers from f to f+G−1 on the display.

2. The method of claim 1, wherein the first value is 0.3 F.

3. The method of claim 1, wherein the second value is 0.7 F.

4. The method of claim 1, wherein the index is moved up, down, left, or right.

5. The method of claim 1, wherein the electronic device comprises a storage storing the item numbers without displaying.

6. The method of claim 1, wherein the electronic device comprises a memory having G groups of memory blocks to cache the images from f to f+G−1.

7. The method of claim 6, wherein each group comprises two memory units, one memory unit stores the image numbers, and another memory unit caches the corresponding images.

8. The method of claim 1, wherein a display module decodes and enlarges the images to display when the images are first displayed.

9. The method of claim 1, wherein the display is a touch display.

10. An electronic device capable of browsing images, the electronic device comprising:
a display capable of displaying an index, the index defining F items, each item having an item number, the display capable of displaying G images, the item with the item number F/2 located at a center of the display; and
a storage capable of storing N images, image numbers defined from 1 to N;
wherein the index is capable of moving along a first direction, the display is capable of displaying the items with the item numbers from f to f+G−1, the item with the item number F/2 is capable of being moved to the center of the display if the item number f is smaller than a first value adjacent to 1 or bigger than a second value adjacent to F, the display is capable of displaying the images with the image numbers corresponding to the item numbers from f to f+G−1.

11. The electronic device of claim 10, wherein the first value is 0.3 F.

12. The electronic device of claim 10, wherein the second value is 0.7 F.

13. The electronic device of claim 10, wherein the index is capable of being moved up, down, left, or right.

14. The electronic device of claim 10, wherein the electronic device comprises a storage storing the item numbers without displaying.

15. The electronic device of claim 10, wherein the electronic device comprises a memory having G groups of memory blocks to cache the images from f to f+G−1.

16. The electronic device of claim 15, wherein each group comprises two memory units, one memory unit stores the image numbers, and another memory unit caches the corresponding images.

17. The electronic device of claim 10, wherein the electronic device further comprises a display module capable of decoding and enlarging the images to display when the images are first displayed.

18. The electronic device of claim 10, wherein the display is a touch display.
